(19) United States
(12) Patent Application Publication
(10) Pub. No.: US 2026/0129676 A1
(43) Pub. Date: May 7, 2026

(54) CHANNEL DETECTION METHOD AND APPARATUS

(71) Applicant: BEIJING XIAOMI MOBILE SOFTWARE CO., LTD., Beijing (CN)

(72) Inventor: Yajun ZHU, Beijing (CN)

(21) Appl. No.: 19/115,219

(22) PCT Filed: Sep. 27, 2022
(86) PCT No.: PCT/CN2022/121902

§ 371 Date: Mar. 25, 2025

(51) Int. Cl. H04W 74/0808; H04W 72/0446; H04W 72/0453; H04W 72/1268

(52) U.S. Cl. CPC H04W 74/0808; H04W 72/0446; H04W 72/0453; H04W 72/1268

(57) ABSTRACT

A method for channel detection, performed by a base station, includes: in response to determining that interference caused by downlink transmission to an interfered cell of an interfered base station meets a first condition, scheduling channel detection before performing downlink transmission to a terminal.

### CROSS-REFERENCE TO RELATED APPLICATION

This application is a U.S. national stage application of International Application No. PCT/CN2022/121902, filed Sep. 27, 2022, the entire contents of which are incorporated herein by reference.

### FIELD

The present disclosure relates to the field of communication technology, and more particularly to a method and apparatus for channel detection.

### BACKGROUND

In a TDD (Time Division Duplexing) system, TDD configuration of adjacent cells maintains the consistent transmission direction, so that no serious cross-interference occurs.

In the related art, in order to better adapt to the transmission of services, a solution is proposed for the base station to dynamically adjust the TDD configuration. In such a case, the problem of cross-interference between uplink and downlink transmissions among different cells needs to be solved.

Furthermore, for the case of dynamic TDD, co-channel interference is generally caused by deployment within the same operator.

### SUMMARY

In a first aspect, embodiments of the present disclosure provide a method for channel detection, which is performed by a base station, and includes: in response to determining that interference caused by downlink transmission to an interfered cell meets a preset condition, determining to perform (scheduling) channel detection before performing downlink transmission to a terminal.

In a second aspect, embodiments of the present disclosure provide another method for channel detection, which is performed by a terminal, and includes: receiving indication information sent by a base station, where the indication information is configured to indicate, to the terminal, to cancel uplink transmission on a time domain resource and/or a frequency domain resource indicated by configuration information; and the configuration information is determined by the base station according to auxiliary information of an interfered base station corresponding to an interfered cell in a case where it is determined that interference caused by downlink transmission to the interfered cell meets a preset condition; and canceling, according to the indication information, the uplink transmission on the time domain resource and/or the frequency domain resource indicated by the configuration information.

In a third aspect, embodiments of the present disclosure provide yet another method for channel detection, which is performed by a terminal, and includes: in response to determining that interference caused by uplink transmission to an interfered terminal meets a preset condition, determining to perform channel detection before performing uplink transmission to a base station.

In a fourth aspect, embodiments of the present disclosure provide a communication apparatus having some or all of the functions of the base station for implementing the method as described in the first aspect above. For example, the communication apparatus may have functions as described in some or all the embodiments in the present disclosure, or may have functions for implementing any of embodiments of the present disclosure alone. The functions may be implemented by hardware or software executed on corresponding hardware. The hardware or software includes one or more units or modules corresponding to the functions described above.

In an implementation, the communication apparatus may include a transceiver module and a processing module in structure. The processing module is configured to support the communication apparatus to perform the corresponding functions of the method described above. The transceiver module is configured to support communications between the communication apparatus and other devices. The communication apparatus may further include a storage module for coupling with the transceiver module and the processing module, and storing computer programs and data necessary for the communication apparatus.

In an implementation, the communication apparatus includes a processing module, configured to determine to perform channel detection before performing downlink transmission to a terminal, in response to determining that interference caused by downlink transmission to an interfered cell meets a first condition.

In a fifth aspect, embodiments of the present disclosure provide another communication apparatus, having some or all of the functions of the terminal for implementing the method examples as described in the second aspect above. For example, the communication apparatus may have functions as described in some or all the embodiments in the present disclosure, or may have functions for implementing any of embodiments of the present disclosure alone. The functions may be implemented by hardware or software executed on corresponding hardware. The hardware or software includes one or more units or modules corresponding to the functions described above.

In an implementation, the communication apparatus may include a transceiver module and a processing module in structure. The processing module is configured to support the communication apparatus to perform the corresponding functions of the method described above. The transceiver module is configured to support communications between the communication apparatus and other devices. The communication apparatus may further include a storage module for coupling with the transceiver module and the processing module, and storing computer programs and data necessary for the communication apparatus.

In an implementation, the communication apparatus includes: a transceiver module, configured to receive indication information sent by a base station, where the indication information is configured to indicate, to a terminal, to cancel uplink transmission on a time domain resource and/or a frequency domain resource indicated by configuration information; and the configuration information is determined by the base station according to auxiliary information of an interfered base station corresponding to an interfered cell in a case where it is determined that interference caused by downlink transmission to the interfered cell meets a first condition; and a processing module, further configured to cancel, according to the indication information, the uplink transmission on the time domain resource and/or the frequency domain resource indicated by the configuration information.

In a sixth aspect, embodiments of the present disclosure provide another communication apparatus, having some or all of the functions of the terminal for implementing the method examples as described in the third aspect above. For example, the communication apparatus may have functions as described in some or all the embodiments in the present disclosure, or may have functions for implementing any of embodiments of the present disclosure alone. The functions may be implemented by hardware or software executed on corresponding hardware. The hardware or software includes one or more units or modules corresponding to the functions described above.

In an implementation, the communication apparatus may include a transceiver module and a processing module in structure. The processing module is configured to support the communication apparatus to perform the corresponding functions of the method described above. The transceiver module is configured to support communications between the communication apparatus and other devices. The communication apparatus may further include a storage module for coupling with the transceiver module and the processing module, and storing computer programs and data necessary for the communication apparatus.

In an implementation, the communication apparatus includes: a processing module, configured to determine to perform channel detection before performing uplink transmission to a base station, in response to determining that interference caused by uplink transmission to an interfered terminal meets a second condition.

In a seventh aspect, embodiments of the present disclosure provide a communication apparatus, which includes a processor. When the processor calls a computer program in a memory, the method as described in the first aspect above is executed.

In an eighth aspect, embodiments of the present disclosure provide a communication apparatus, which includes a processor. When the processor calls a computer program in a memory, the method as described in the second aspect above is executed.

In a ninth aspect, embodiments of the present disclosure provide a communication apparatus, which includes a processor. When the processor calls a computer program in a memory, the method as described in the third aspect above is executed.

In a tenth aspect, embodiments of the present disclosure provide a communication apparatus, which includes: a processor; and a memory, having stored therein computer programs. The processor is configured to execute the computer programs stored in the memory to cause the communication apparatus to perform the method as described in the first aspect.

In an eleventh aspect, embodiments of the present disclosure provide a communication apparatus, which includes: a processor; and a memory, having stored therein computer programs. The processor is configured to execute the computer programs stored in the memory to cause the communication apparatus to perform the method as described in the second aspect.

In a twelfth aspect, embodiments of the present disclosure provide a communication apparatus, which includes: a processor; and a memory, having stored therein computer programs. The processor is configured to execute the computer programs stored in the memory to cause the communication apparatus to perform the method as described in the third aspect.

In a thirteenth aspect, embodiments of the present disclosure provide a communication apparatus, which includes: a processor; and an interface circuit, configured to receive code instructions and transmit the code instructions to the processor. The processor is configured to run the code instructions to cause the apparatus to perform the method as described in the first aspect.

In a fourteenth aspect, embodiments of the present disclosure provide a communication apparatus, which includes: a processor; and an interface circuit, configured to receive code instructions and transmit the code instructions to the processor. The processor is configured to run the code instructions to cause the apparatus to perform the method as described in the second aspect.

In a fifteenth aspect, embodiments of the present disclosure provide a communication apparatus, which includes: a processor; and an interface circuit, configured to receive code instructions and transmit the code instructions to the processor. The processor is configured to run the code instructions to cause the apparatus to perform the method as described in the third aspect.

In a sixteenth aspect, embodiments of the present disclosure provides a system for channel detection, and the system includes the communication apparatus of the fourth aspect, the communication apparatus of the fifth aspect, and the communication apparatus of the sixth aspect, or the system includes the communication apparatus of the seventh aspect, the communication apparatus of the eighth aspect, and the communication apparatus of the ninth aspect, or the system includes the communication apparatus of the tenth aspect, the communication apparatus of the eleventh aspect, and the communication apparatus of the twelfth aspect, or the system includes the communication apparatus of the thirteenth aspect, the communication apparatus of the fourteenth aspect, and the communication apparatus of the fifteenth aspect.

In a seventeenth aspect, embodiments of the present invention provide a computer-readable storage medium, having stored therein instructions that are to be used by the base station, and the instructions, when executed, cause the base station to perform the method as described in the first aspect.

In an eighteenth aspect, embodiments of the present invention provide a readable storage medium, having stored therein instructions that are to be used by the terminal, and the instructions, when executed, cause the terminal to perform the method as described in the second aspect.

In a nineteenth aspect, embodiments of the present invention provide a readable storage medium, having stored therein instructions that are to be used by the terminal, and the instructions, when executed, cause the terminal to perform the method as described in the third aspect.

In a twentieth aspect, the present disclosure further provides a computer program product that includes a computer program, and when run on a computer, causes the computer to perform the method as described in the first aspect.

In a twenty-first aspect, the present disclosure further provides a computer program product that includes a computer program, and when run on a computer, causes the computer to perform the method as described in the second aspect.

In a twenty-second aspect, the present disclosure further provides a computer program product that includes a computer program, and when run on a computer, causes the computer to perform the method as described in the third aspect.

In a twenty-third aspect, the present disclosure provides a chip system, which includes at least one processor and at least one interface, for supporting the base station to implement the functions involved in the first aspect, for example, determining or processing at least one of the data and information involved in the above method. In a possible design, the chip system also includes a memory, which is used to store computer programs and data necessary for the base station. The chip system may be composed of chips, or it may include chips and other discrete devices.

In a twenty-fourth aspect, the present disclosure provides a chip system, which includes at least one processor and at least one interface, for supporting the terminal to implement the functions involved in the second aspect, for example, determining or processing at least one of the data and information involved in the above method. In a possible design, the chip system also includes a memory, which is used to store computer programs and data necessary for the terminal. The chip system may be composed of chips, or it may include chips and other discrete devices.

In a twenty-fifth aspect, the present disclosure provides a chip system, which includes at least one processor and at least one interface, for supporting the terminal to implement the functions involved in the third aspect, for example, determining or processing at least one of the data and information involved in the above method. In a possible design, the chip system also includes a memory, which is used to store computer programs and data necessary for the base station. The chip system may be composed of chips, or it may include chips and other discrete devices.

In a twenty-sixth aspect, the present disclosure provides a computer program that, when run on a computer, causes the computer to perform the method as described in the first aspect.

In a twenty-seventh aspect, the present disclosure provides a computer program that, when run on a computer, causes the computer to perform the method as described in the second aspect.

In a twenty-eighth aspect, the present disclosure provides a computer program that, when run on a computer, causes the computer to perform the method as described in the third aspect.

### BRIEF DESCRIPTION OF THE DRAWINGS

Drawings for the description of embodiments of the present disclosure are briefly described below.

FIG. 1 is an architecture diagram of a communication system according to embodiments of the present disclosure;

FIG. 2 is a schematic diagram showing co-channel interference between base stations and co-channel interference between terminals according to embodiments of the present disclosure;

FIG. 3 is a flowchart of a method for channel detection according to embodiments of the present disclosure;

FIG. 4 is a flowchart of another method for channel detection according to embodiments of the present disclosure;

FIG. 5 is a flowchart of yet another method for channel detection according to embodiments of the present disclosure;

FIG. 6 is a flowchart of yet another method for channel detection according to embodiments of the present disclosure;

FIG. 7 is a flowchart of yet another method for channel detection according to embodiments of the present disclosure;

FIG. 8 is a flowchart of yet another method for channel detection according to embodiments of the present disclosure;

FIG. 9 is a flowchart of yet another method for channel detection according to embodiments of the present disclosure;

FIG. 10 is a flowchart of yet another method for channel detection according to embodiments of the present disclosure;

FIG. 11 is a block diagram of a communication apparatus according to embodiments of the present disclosure;

FIG. 12 is a block diagram of another communication apparatus according to embodiments of the present disclosure; and

FIG. 13 is schematic block diagram of a chip according to embodiments of the present disclosure.

### DETAILED DESCRIPTION

For better understanding of the method and apparatus for channel detection according to embodiments of the present disclosure, a communication system to which embodiments of the present disclosure are applicable is described first below.

Reference will now be made in detail to illustrative embodiments of the present disclosure, examples of which are illustrated in the accompanying drawings. The following description refers to the accompanying drawings in which the same numbers in different drawings represent the same or similar elements unless otherwise represented. The implementations described in the following illustrative embodiments do not represent all implementations consistent with embodiments of the present disclosure. Instead, they are merely examples of apparatuses and methods consistent with some aspects of the present disclosure as recited in the appended claims.

Terms used in embodiments of the present disclosure are only for the purpose of describing specific embodiments, but should not be construed to limit the present disclosure. As used in the present disclosure and the appended claims, “a/an”, “said” and “the” in singular forms are intended to include plural forms, unless clearly indicated in the context otherwise. It should also be understood that, the term “and/or” used herein represents and contains any one or any possible combinations of one or more associated items listed.

It should be understood that, although terms such as “first,” “second” and “third” may be used in the present disclosure for describing various information, these information should not be limited by these terms. These terms are only used for distinguishing information of the same type from each other. For example, first information may also be referred to as second information, and similarly, the second information may also be referred to as the first information, without departing from the scope of the present disclosure. Depending on the context, the term “if” as used herein may be construed to mean “when” or “upon” or “in response to determining”.

It should be noted that information (including, but not limited to, user equipment information, user personal information, etc.), data (including, but not limited to, data used for analysis, stored data, displayed data, etc.) and signals involved in the present disclosure are all authorized by users or fully authorized by all parties, and collection, use and processing of relevant data need to comply with relevant laws, regulations and standards of relevant countries and regions.

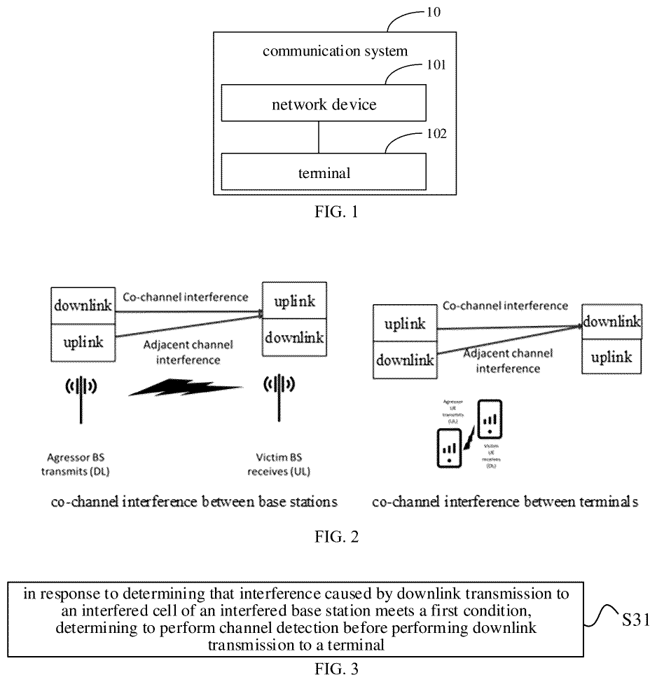

Referring to FIG. 1, FIG. 1 is a schematic architecture diagram of a communication system according to embodiments of the present disclosure. The communication system may include, but not limited to, a base station and a terminal. The number and forms of the devices shown in FIG. 1 are only used as an example, and do not constitute a limitation on embodiments of the present disclosure. In actual applications, two or more base stations and two or more terminals may be included. As an example for illustration, the communication system 10 shown in FIG. 1 includes one network device 101 and one terminal 102.

It should be noted that the technical solutions as set forth in embodiments of the present disclosure may be applied to various communication systems, for example, a long term evolution (LTE) system, a 5th generation (5G) mobile communication system, a 5G new radio (NR) system, or other new mobile communication systems in the future.

The base station 101 in embodiments of the present disclosure is an entity at a network side for sending or receiving signals. For example, the base station 101 may be an evolved NodeB (eNB), a transmission reception point (TRP), a next generation NodeB (gNB) in an NR system, a base station in other future mobile communication systems, or an access node in a wireless fidelity (WiFi) system. Embodiments of the present disclosure do not limit the specific technique and specific device form adopted by the base station. The base station according to embodiments of the present disclosure may be composed of a central unit (CU) and distributed units (DUs). The CU may also be called a control unit. The CU-DU structure allows to split protocol layers of the network device, such as a base station, functions of some protocol layers are centrally controlled in the CU, functions of some or all of the remaining protocol layers are distributed in the DUs, and the CU centrally controls the DUs.

The terminal 102 in embodiments of the present disclosure is an entity at a user side for receiving or sending signals, such as a mobile phone. The terminal may also be called a terminal device, a user equipment (UE), a mobile station (MS), a mobile terminal (MT), and so on. The terminal may be a device with a communication function, such as a car, a smart car, a mobile phone, a wearable device, a tablet Pad, a computer with a wireless transceiving function, a virtual reality (VR) terminal, an augmented reality (AR) terminal, a wireless terminal in an industrial control, a wireless terminal in a self-driving, a wireless terminal in a remote medical surgery, a wireless terminal in a smart grid, a wireless terminal in a transportation safety, a wireless terminal in a smart city, a wireless terminal in a smart home, etc. Embodiments of the present disclosure do not limit the specific technique and the specific device form adopted by the terminal.

It may be understood that the communication system described in embodiments of the present disclosure is intended to illustrate the technical solutions as set forth in embodiments of the present disclosure more clearly, and does not constitute a limitation on the technical solutions as set forth in embodiments of the present disclosure. Those of ordinary skill in the art will know that with the evolution of the system architecture and the emergence of new service scenarios, the technical solutions as set forth in embodiments of the present disclosure are also applicable to similar technical problems.

In addition, in order to facilitate understanding of the embodiments of the present disclosure, the following explanations are provided.

First, in embodiments of the present disclosure, “configured to indicate” may include being configures for direct indication and being configured for indirect indication. When describing that certain information is configured to indicate A, it may include that the information directly indicates A or indirectly indicates A, but it does not mean that the information must carry A. For example, the information may carry other messages from which A may be determined.

The information indicated by certain information is called the information to be indicated. In the specific implementation process, there are many ways to indicate the information to be indicated, such as but not limited to, directly indicating the information to be indicated, such as the information to be indicated itself or the index of the information to be indicated. The information to be indicated may also be indirectly indicated by indicating other information, in which there is an association between the other information and the information to be indicated. It is also possible to indicate only a part of the information to be indicated, while the other parts of the information to be indicated are known or agreed in advance. For example, the indication of specific information may also be achieved by means of the arrangement order of each information agreed in advance (such as specified by a protocol), thereby reducing the indication overhead to a certain extent.

The information to be indicated may be sent as a whole or divided into multiple sub-information and sent separately, and the sending period and/or sending time of these sub-information may be the same or different. The specific sending method is not limited in the present disclosure. The sending period and/or sending time of these sub-information may be predefined, for example, predefined according to a protocol.

Second, the first, second and various digital numbers in the present disclosure are only used for the convenience of description and are not used to limit the scope of the embodiments of the present disclosure, for example, to distinguish different conditions, etc.

Third, in the present disclosure, “preset” may include indication by a signaling from a base station, or predefined, such as protocol-defined. Among them, “predefined” may be implemented by pre-saving corresponding codes, tables or other means that may be used to indicate relevant information in an apparatus (for example, including a terminal and a base station), and the specific implementation is not limited in the present disclosure.

Fourth, the “protocol” involved in embodiments of the present disclosure may refer to a standard protocol in the field of communication, for example, it may include an LTE protocol, an NR protocol, and related protocols applicable to future communication systems, and it is not limited in the present disclosure.

Fifth, the embodiments of the present disclosure list multiple implementations to clearly illustrate the technical solutions described herein. Of course, those skilled in the art may understand that the multiple implementations provided in the embodiments of the present disclosure may be performed individually, in combination with other embodiments herein, or in conjunction with methods from related technologies. It is not limited in the embodiments of the present disclosure.

In order to better understand the technical solutions described in any embodiment of the present disclosure, firstly, the application scenarios in the related technologies are explained.

In an embodiment, the enhancement of the full-duplex transmission mode is only for the base station side, while the terminal side still only supports the half-duplex transmission mode. This is due to the fact that simultaneous transmission and reception on one carrier require both the transmitting and receiving ends to effectively suppress cross-timeslot interference and self-interference. For cross-slot interference, it may be measured, avoided and eliminated through a certain mechanism. For self-interference, high transmit-receive isolation is required for the device to achieve strong self-interference suppression capabilities. Generally speaking, full-duplex transmission mode may lead to increased throughput, reduced transmission latency (especially for uplink transmission), and enhanced uplink coverage. To achieve the aforementioned objectives, uplink transmission needs to be scheduled in the downlink region of time division duplexing (TDD) frequency bands or in the downlink spectrum of frequency division duplexing (FDD) frequency bands. According to the relevant protocol, the terminal will not send uplink data in the downlink time slot. Therefore, the base station needs to indicate to the terminal the frequency range that may be used for uplink transmission within the downlink time slot. However, there is no clear method to indicate the resources used for uplink data transmission within the downlink time slot.

In an embodiment, data reception and transmission may be performed simultaneously within a time slot. To minimize the impact on terminal complexity and radio frequency, the research on duplex mode enhancement may be limited to the base station side, that is, full-duplex is only supported on the base station side.

Illustratively, FIG. 2 shows co-channel interference between base stations and co-channel interference between terminals.

In some embodiments, there are mainly three types of full-duplex schemes on the base station side:
non-overlapping sub-bands, where uplink and downlink data are transmitted on different sub-bands without overlapping in the frequency domain;
partially overlapping subbands, where uplink and downlink data are transmitted on different sub-bands with partial overlapping in the frequency domain;
in-band full-duplex, where uplink and downlink data may be transmitted on completely overlapping frequency domain resources.

It may be understood that since the variations of cross-link interference (CLI) is dynamic, CLI measurement in related technologies cannot respond to the actual interference environment. Solutions based on channel access are supported in unlicensed frequency bands, and in related technologies, channel access solution is to ensure coexistence among heterogeneous systems from a regulatory perspective.

Moreover, in the case of dynamic TDD, co-channel interference is generally caused by deployments within the same operator. Therefore, how to perform efficient channel detection is an urgent problem to be solved.

Based on this, an embodiment of the present disclosure provides a method for channel detection to reduce mutual interference between transmissions among different nodes and improve the performance of the system.

Embodiments of the present disclosure provide a method and apparatus for channel detection, which may realize efficient channel detection, and control downlink transmission according to the channel detection result obtained by performing channel detection, thereby avoiding interference and improving the performance of the system.

The method and apparatus for channel detection provided in the present disclosure will be described in detail below with reference to the accompanying drawings.

Reference is made to FIG. 3, which is a flowchart of a method for channel detection provided in an embodiment of the present disclosure.

As shown in FIG. 3, the method is performed by a base station, and may include, but is not limited to, the following steps.

In step S31: in response to determining that interference caused by downlink transmission to an interfered cell of an interfered base station meets a first condition, it is determined to perform channel detection before performing downlink transmission to a terminal.

In embodiments of the present disclosure, the base station determines to perform channel detection before performing downlink transmission to a terminal, in a case where it is determined that interference caused by downlink transmission to an interfered cell of an interfered base station exits and meets a first condition.

The base station and the interfered base station are different base stations, in which the interfered base station is adjacent to the base station, or the cell corresponding to the interfered base station is adjacent to the cell corresponding to the base station.

The first condition may be to determine that interference caused by downlink transmission to an interfered cell of an interfered base station exits, or that interference caused by downlink transmission to an interfered cell of an interfered base station exceeds a predefined threshold.

It may be understood that for the scenario of interference between base stations, the base station may measure whether its downlink transmission will cause interference to other cells, so as to determine the interference to the interfered cell.

It may be understood that, the base station determines to perform channel detection before performing downlink transmission to the terminal and obtain a channel detection result. According to the channel detection result, the base station determines whether to perform downlink transmission to the terminal.

For example, in a case where the base station detects that the channel resources for downlink transmission are occupied, the downlink transmission to the terminal may be canceled. Alternatively, in a case where the base station detects that the channel resources for downlink transmission are not occupied, the downlink transmission to the terminal may be performed.

Based on this, in embodiments of the present disclosure, the base station determines to perform channel detection before performing downlink transmission to a terminal, in a case where it is determined that interference caused by downlink transmission to an interfered cell of an interfered base station exits and meets a first condition. It is possible to realize efficient channel detection, and control downlink transmission according to the channel detection result obtained by performing channel detection, thereby avoiding interference and improving the performance of the system.

It may be understood that in embodiments of the present disclosure, in case that the base station performs channel detection before performing downlink transmission to the terminal, the base station may perform channel detection on the channel resources used for downlink transmission, or the base station may also obtain auxiliary information of the interfered base station corresponding to the interfered cell for downlink transmission, and by comparing the auxiliary information of the interfered base station for downlink transmission with the channel resources used by the base station for downlink transmission, the channel resources on which channel detection needs to be performed are determined and efficient channel detection is achieved.

In some embodiments, the base station performs channel detection before performing downlink transmission to the terminal, and the method for performing channel detection includes as follows: the base station determines auxiliary information of the interfered base station corresponding to the interfered cell; and determines configuration information for performing channel detection according to the auxiliary information.

It may be understood that in case that the base station determines the auxiliary information of the interfered base station corresponding to the interfered cell, the base station may determine the relevant information of the interfered base station when performing channel access, such as: the time domain resources, frequency domain resources, etc. used by the interfered base station in downlink transmission.

Based on this, in a case where the base station determines the auxiliary information of the interfered base station corresponding to the interfered cell, the base station may determine the configuration information for the base station to perform channel detection.

In embodiments of the present disclosure, the base station may determine the auxiliary information of the interfered base station by itself or in other ways.

In some possible implementations, the base station determines the auxiliary information of the interfered base station by interacting the relevant configuration for performing channel access with the interfered base station of the interfered cell to determine the auxiliary information of the interfered base station.

Based on this, the base station may determine the configuration information for performing channel detection according to the auxiliary information of the interfered base station. The configuration information includes one or more of the time domain configuration, frequency domain configuration, a channel detection mechanism, and a frequency domain unit for performing channel detection with which the base station may determine to perform channel access. Thus, the base station may determine to perform channel detection on the time domain resource and/or the frequency domain resource indicated by the configuration information based on the configuration information.

In some embodiments, the configuration information includes at least one of:
a time domain resource range for performing the channel detection;
a frequency domain resource range for performing the channel detection;
a channel detection mechanism; or
a frequency domain channel unit for the channel detection.

In embodiments of the present disclosure, the base station determines the configuration information for performing channel detection, and the configuration information includes the time domain resource range for performing channel detection. Thus, the base station may perform channel detection within the time domain resource range, and may achieve efficient channel detection.

The time domain resource range may be one or more orthogonal frequency division multiplexing (OFDM) symbols, time slots, sub-frames, radio frames or other time domain units that are continuous in the time domain; or the time domain resource range may also be one or more OFDM symbols, time slots, sub-frames, radio frames or other time domain units that are discontinuous in the time domain, and so on.

In embodiments of the present disclosure, the base station determines the configuration information for performing channel detection, and the configuration information includes the frequency domain resource range for performing channel detection. Thus, the base station may perform channel detection within the frequency domain resource range, and may achieve efficient channel detection.

The frequency domain resource range may be one or more sub-carriers (SCs), resource blocks (RBs), resource block sets (RB sets), bandwidth parts (BWPs) or other frequency domain units that are continuous in the frequency domain; or the frequency domain resource range may be one or more SCs, RBs, RB sets, BWPs or other frequency domain units that are discontinuous in the frequency domain, and so on.

In embodiments of the present disclosure, the base station determines the configuration information for performing channel detection, and the configuration information includes the channel detection mechanism. The channel detection mechanism indicates the method for channel detection and the channel detection configuration. Thus, the base station may perform channel detection according to the determined channel detection mechanism, and may achieve efficient channel detection.

In embodiments of the present disclosure, the base station determines the configuration information for performing channel detection, and the configuration information includes the frequency domain channel unit for the channel detection. Thus, the base station may perform channel detection on the frequency domain channel unit for channel detection, thereby achieving efficient channel detection.

The frequency domain channel unit for channel detection may indicate the basic channel unit for performing channel detection. The basic channel unit may be one or more SCs, RBs, RB sets, BWPs or other frequency domain units that are continuous in the frequency domain; or the basic channel unit may also be one or more SCs, RBs, RB sets, BWPs or other frequency domain units that are discontinuous in the frequency domain, and so on.

For example, 6 RBs are used as a basic channel detection unit, or 10 MHz bandwidth is used as a basic channel unit.

It should be noted that the above embodiments are not exhaustive but are only illustrations of some embodiments, and the above embodiments may be implemented individually or in combination. The above embodiments are only for illustration and are not intended to be specific limitations on the scope of protection of the embodiments of the present disclosure.

In some possible implementations, after determining the configuration information for performing channel detection, the base station may send an indication to the terminal it serves to indicate to the terminal not to perform uplink transmission on the time domain resource and/or the frequency domain resource indicated by the configuration information.

In some embodiments, the base station sends indication information to the terminal, in which the indication information is configured to indicate, to the terminal, to cancel uplink transmission on the time domain resource and/or the frequency domain resource indicated by the configuration information.

In embodiments of the present disclosure, the base station sends indication information to the terminal, in which the indication information is configured to indicate, to the terminal, to cancel uplink transmission on the time domain resource and/or the frequency domain resource indicated by the configuration information. Thus, the uplink transmission of the terminal is prevented from interfering with the downlink transmission of the interfering base station, thereby avoiding transmission failure or data loss.

In some embodiments, the base station performs channel detection on the time domain resource and/or the frequency domain resource indicated by the configuration information, and generates a channel detection result.

In an embodiment of the present disclosure, the base station determines to perform channel detection. In a case where the base station determines auxiliary information of an interfered base station corresponding to an interfered cell, and determines configuration information for performing channel detection according to the auxiliary information, the base station may determine to perform channel detection on the time domain resource and/or the frequency domain resource indicated by the configuration information to generate a channel detection result.

It may be understood that after the base station performs channel detection and obtains the channel detection result, it may determine whether the detected channel resource is occupied. In a case where the channel resource is occupied, the base station may abandon downlink data transmission and cancel downlink transmission to the terminal, or it may adjust the downlink transmission parameter to reduce interference to the interfered cell.

By implementing the embodiments of the present disclosure, the base station determines to perform channel detection before performing downlink transmission to a terminal, in response to determining that interference caused by downlink transmission to an interfered cell of an interfered base station exits and meets a first condition. In this way, it is possible to realize efficient channel detection, and control downlink transmission according to the channel detection result obtained by performing channel detection, thereby avoiding interference and improving the performance of the system.

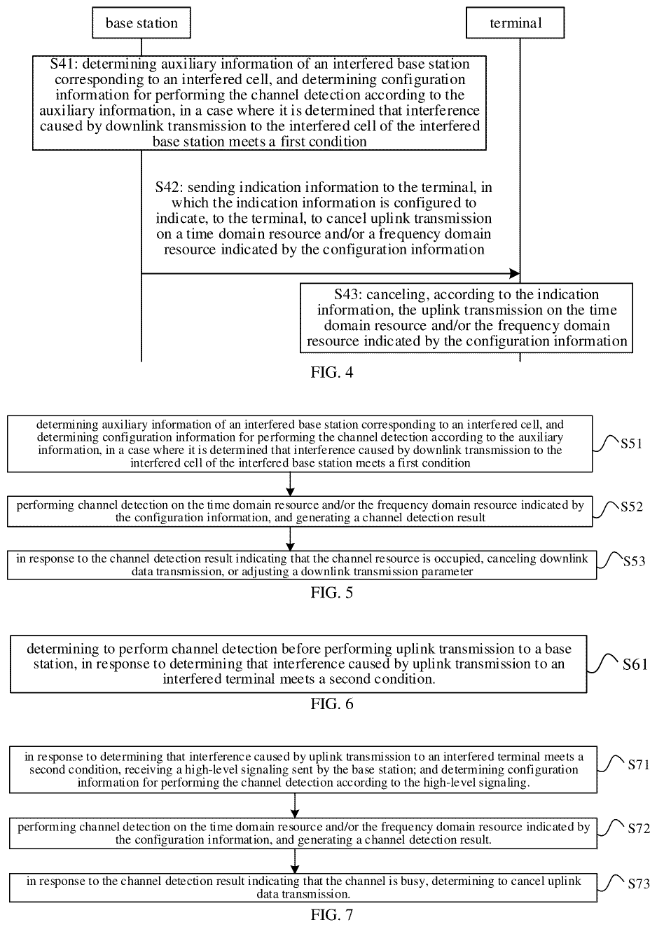

Reference is made to FIG. 4, which is a flow chart of another method for channel detection provided in an embodiment of the present disclosure. As shown in FIG. 4, the method may include but is not limited to the following steps.

In step S41: the base station determines auxiliary information of an interfered base station corresponding to an interfered cell, and determines configuration information for performing the channel detection according to the auxiliary information, in a case where it is determined that interference caused by downlink transmission to the interfered cell of the interfered base station meets a first condition.

Regarding the relevant description of S41, reference may be made to the relevant description in the above embodiment, which will not be repeated here.

In some embodiments, the configuration information includes at least one of:
a time domain resource range for performing the channel detection;
a frequency domain resource range for performing the channel detection;
a channel detection mechanism; or
a frequency domain channel unit for the channel detection.

In embodiments of the present disclosure, the base station determines the configuration information for performing channel detection, and the configuration information includes the time domain resource range for performing channel detection. Thus, the base station may perform channel detection within the time domain resource range, and may achieve efficient channel detection.

The time domain resource range may be one or more OFDM symbols, time slots, sub-frames, radio frames or other time domain units that are continuous in the time domain; or the time domain resource range may also be one or more OFDM symbols, time slots, sub-frames, radio frames or other time domain units that are discontinuous in the time domain, and so on.

In embodiments of the present disclosure, the base station determines the configuration information for performing channel detection, and the configuration information includes the frequency domain resource range for performing channel detection. Thus, the base station may perform channel detection within the frequency domain resource range, and may achieve efficient channel detection.

The frequency domain resource range may be one or more SCs, RBs, RB sets, BWPs or other frequency domain units that are continuous in the frequency domain; or the frequency domain resource range may be one or more SCs, RBs, RB sets, BWPs or other frequency domain units that are discontinuous in the frequency domain, and so on.

In embodiments of the present disclosure, the base station determines the configuration information for performing channel detection, and the configuration information includes the channel detection mechanism. The channel detection mechanism indicates the method for channel detection and the channel detection configuration. Thus, the base station may perform channel detection according to the determined channel detection mechanism, and may achieve efficient channel detection.

In embodiments of the present disclosure, the base station determines the configuration information for performing channel detection, and the configuration information includes the frequency domain channel unit for the channel detection. Thus, the base station may perform channel detection on the frequency domain channel unit for channel detection, thereby achieving efficient channel detection.

The frequency domain channel unit for channel detection may indicate the basic channel unit for performing channel detection. The basic channel unit may be one or more SCs, RBs, RB sets, BWPs or other frequency domain units that are continuous in the frequency domain; or the basic channel unit may also be one or more SCs, RBs, RB sets, BWPs or other frequency domain units that are discontinuous in the frequency domain, and so on.

For example, 6 RBs are used as a basic channel detection unit, or 10 MHz bandwidth is used as a basic channel unit.

It should be noted that the above embodiments are not exhaustive but are only illustrations of some embodiments, and the above embodiments may be implemented individually or in combination. The above embodiments are only for illustration and are not intended to be specific limitations on the scope of protection of the embodiments of the present disclosure.

In step S42: the base station sends indication information to the terminal, in which the indication information is configured to indicate, to the terminal, to cancel uplink transmission on a time domain resource and/or a frequency domain resource indicated by the configuration information.

In embodiments of the present disclosure, the base station sends indication information to the terminal, and the indication information is configured to indicate, to the terminal, to cancel uplink transmission on a time domain resource and/or a frequency domain resource indicated by the configuration information.

In step S43: the terminal cancels, according to the indication information, the uplink transmission on the time domain resource and/or the frequency domain resource indicated by the configuration information.

In embodiments of the present disclosure, after receiving the indication information sent by the base station, the terminal may cancel the uplink transmission on the time domain resource and/or the frequency domain resource indicated by the configuration information according to the indication information. Thus, the uplink transmission of the terminal is prevented from interfering with the downlink transmission of the interfering base station, thereby avoiding transmission failure or data loss.

It should be noted that in embodiments of the present disclosure, S41 to S43 may be implemented separately or in combination with any one of the other steps in embodiments of the present disclosure, for example, in combination with S31 in embodiments of the present disclosure, and it is not limited in embodiments of the present disclosure.

By implementing embodiments of the present disclosure, the base station determines auxiliary information of an interfered base station corresponding to an interfered cell, and determines configuration information for performing the channel detection according to the auxiliary information, in a case where it is determined that interference caused by downlink transmission to the interfered cell of the interfered base station meets a first condition. The base station sends indication information to the terminal, in which the indication information is configured to indicate, to the terminal, to cancel uplink transmission on a time domain resource and/or a frequency domain resource indicated by the configuration information. In this way, it is possible to realize efficient channel detection, and control uplink and downlink transmission according to the configuration information for performing channel detection, thereby avoiding interference and improving the performance of the system.

Reference is made to FIG. 5, which is a flow chart of yet another method for channel detection provided in an embodiment of the present disclosure. As shown in FIG. 5, the method may include but is not limited to the following steps.

In step S51: the base station determines auxiliary information of an interfered base station corresponding to an interfered cell, and determines configuration information for performing the channel detection according to the auxiliary information, in a case where it is determined that interference caused by downlink transmission to the interfered cell of the interfered base station meets a first condition.

Regarding the relevant description of S51, reference may be made to the relevant description in the above embodiment, which will not be repeated here.

In some embodiments, the configuration information includes at least one of:
a time domain resource range for performing the channel detection;
a frequency domain resource range for performing the channel detection;
a channel detection mechanism; or
a frequency domain channel unit for the channel detection.

In embodiments of the present disclosure, the base station determines the configuration information for performing channel detection, and the configuration information includes the time domain resource range for performing channel detection. Thus, the base station may perform channel detection within the time domain resource range, and may achieve efficient channel detection.

The time domain resource range may be one or more OFDM symbols, time slots, sub-frames, radio frames or other time domain units that are continuous in the time domain; or the time domain resource range may also be one or more OFDM symbols, time slots, sub-frames, radio frames or other time domain units that are discontinuous in the time domain, and so on.

In embodiments of the present disclosure, the base station determines the configuration information for performing channel detection, and the configuration information includes the frequency domain resource range for performing channel detection. Thus, the base station may perform channel detection within the frequency domain resource range, and may achieve efficient channel detection.

The frequency domain resource range may be one or more SCs, RBs, RB sets, BWPs or other frequency domain units that are continuous in the frequency domain; or the frequency domain resource range may be one or more SCs, RBs, RB sets, BWPs or other frequency domain units that are discontinuous in the frequency domain, and so on.

In embodiments of the present disclosure, the base station determines the configuration information for performing channel detection, and the configuration information includes the channel detection mechanism. The channel detection mechanism indicates the method for channel detection and the channel detection configuration. Thus, the base station may perform channel detection according to the determined channel detection mechanism, and may achieve efficient channel detection.

In embodiments of the present disclosure, the base station determines the configuration information for performing channel detection, and the configuration information includes the frequency domain channel unit for the channel detection. Thus, the base station may perform channel detection on the frequency domain channel unit for channel detection, thereby achieving efficient channel detection.

The frequency domain channel unit for channel detection may indicate the basic channel unit for performing channel detection. The basic channel unit may be one or more SCs, RBs, RB sets, BWPs or other frequency domain units that are continuous in the frequency domain; or the basic channel unit may also be one or more SCs, RBs, RB sets, BWPs or other frequency domain units that are discontinuous in the frequency domain, and so on.

For example, 6 RBs are used as a basic channel detection unit, or 10 MHz bandwidth is used as a basic channel unit.

It should be noted that the above embodiments are not exhaustive but are only illustrations of some embodiments, and the above embodiments may be implemented individually or in combination. The above embodiments are only for illustration and are not intended to be specific limitations on the scope of protection of the embodiments of the present disclosure.

In step S52: the base station performs channel detection on the time domain resource and/or the frequency domain resource indicated by the configuration information, and generates a channel detection result.

In step S53: in response to the channel detection result indicating that the channel resource is occupied, the base station cancels downlink data transmission, or adjusts a downlink transmission parameter.

In an embodiment of the present disclosure, the base station determines to perform channel detection. In a case where the base station determines auxiliary information of an interfered base station corresponding to an interfered cell, and determines configuration information for performing channel detection according to the auxiliary information, the base station may determine to perform channel detection on the time domain resource and/or the frequency domain resource indicated by the configuration information to generate a channel detection result.

It may be understood that after the base station performs channel detection and obtains the channel detection result, it may determine whether the detected channel resource is occupied. In a case where the channel resource is occupied, the base station may abandon downlink data transmission and cancel downlink transmission to the terminal, or it may adjust the downlink transmission parameter to reduce interference to the interfered cell.

It should be noted that in embodiments of the present disclosure, S51 to S53 may be implemented separately or in combination with any one of the other steps in embodiments of the present disclosure, for example, in combination with S31 and/or S41 and S42 in embodiments of the present disclosure, and it is not limited in embodiments of the present disclosure.

By implementing embodiments of the present disclosure, the base station determines auxiliary information of an interfered base station corresponding to an interfered cell, and determines configuration information for performing the channel detection according to the auxiliary information, in a case where it is determined that interference caused by downlink transmission to the interfered cell of the interfered base station meets a first condition. The base station performs channel detection on the time domain resource and/or the frequency domain resource indicated by the configuration information, and generates a channel detection result. In response to the channel detection result indicating that a channel resource is occupied, the base station cancels downlink data transmission, or adjusts a downlink transmission parameter. In this way, it is possible to realize efficient channel detection, and control downlink transmission according to the channel detection result obtained by performing channel detection according to the configuration information for performing channel detection, thereby avoiding interference and improving the performance of the system.

Reference is made to FIG. 6, which is a flow chart of yet another method for channel detection provided in an embodiment of the present disclosure.

As shown in FIG. 6, the method is performed by a terminal, and may include but is not limited to the following steps.

In step S61: the terminal determines to perform channel detection before performing uplink transmission to a base station, in response to determining that interference caused by uplink transmission to an interfered terminal meets a second condition.

In embodiments of the present disclosure, in a case where it is determined that interference caused by uplink transmission to an interfered terminal meets a second condition, the terminal determines to perform channel detection before performing uplink transmission to a base station.

The terminal and the interfered terminal may be different terminals. For example, the interfered terminal and the terminal are located in different cells, and the interfered terminal and the terminal are within the coverage of different base stations.

The terminal determines that the uplink transmission causes interference to the interfered terminal. This may be determined according to an implementation by the terminal, or based on a protocol agreement, or based on an indication by a base station, and so on.

In embodiments of the present disclosure, for the scenario of interference between terminals, the terminal may determine whether the uplink transmission it needs to perform will cause interference to the interfered terminal, and whether the interference meets the second condition.

The second condition may be determining that the uplink transmission will cause interference to the interfered terminal, or the interference caused by the uplink transmission to the interfered terminal exceeding a predefined threshold.

In embodiments of the present disclosure, the predefined threshold may be determined by the terminal according to an implementation, or according to a protocol agreement, or according to an indication by the base station, and so on.

It may be understood that the terminal performs channel detection before performing uplink transmission to the base station, and may obtain the channel detection result. The terminal may determine whether the channel resources it uses are occupied or whether the channel is busy according to the channel detection result.

Based on this, the terminal may determine whether to perform uplink transmission or whether to adjust the uplink transmission parameter according to the channel detection result.

For example, in a case where the terminal determines, based on the channel detection result, that the channel for uplink transmission is busy, the uplink transmission may be canceled, or the uplink transmission parameter may be adjusted.

Based on this, in embodiments of the present disclosure, in a case where it is determined that interference caused by uplink transmission to an interfered terminal meets a second condition, the terminal determines to perform channel detection before performing uplink transmission to a base station. In this way, it is possible to realize efficient channel detection, and control uplink transmission according to the channel detection result obtained by performing channel detection, thereby avoiding interference and improving the performance of the system.

In some possible implementations, determining by the terminal to perform the channel detection before performing the uplink transmission to the base station includes: receiving a high-level signaling sent by the base station; and determining configuration information for performing the channel detection according to the high-level signaling.

In embodiments of the present disclosure, the terminal may receive a high-level signaling from the base station, such as a system signaling, a radio resource control (RRC) signaling, a media access control element (MAC CE), a physical layer signaling, or the like. The configuration information for performing channel detection is determined according to the high-level signaling from the base station.

The configuration information includes one or more of the time domain configuration, frequency domain configuration, a channel detection mechanism, and a frequency domain unit for performing channel detection with which the terminal may determine to perform channel access. Thus, the terminal may determine to perform channel detection on the time domain resource and/or the frequency domain resource indicated by the configuration information based on the configuration information.

In some embodiments, the configuration information includes at least one of:
a time domain resource range for performing the channel detection;
a frequency domain resource range for performing the channel detection;
a channel detection mechanism; or
a frequency domain channel unit for the channel detection.

In embodiments of the present disclosure, the terminal determines the configuration information for performing channel detection according to the high-level signaling, and the configuration information includes the time domain resource range for performing channel detection. Thus, the terminal may perform channel detection within the time domain resource range, and may achieve efficient channel detection.

The time domain resource range may be one or more OFDM symbols, time slots, sub-frames, radio frames or other time domain units that are continuous in the time domain; or the time domain resource range may also be one or more OFDM symbols, time slots, sub-frames, radio frames or other time domain units that are discontinuous in the time domain, and so on.

In embodiments of the present disclosure, the terminal determines the configuration information for performing channel detection according to the high-level signaling, and the configuration information includes the frequency domain resource range for performing channel detection. Thus, the terminal may perform channel detection within the frequency domain resource range, and may achieve efficient channel detection.

The frequency domain resource range may be one or more SCs, RBs, RB sets, BWPs or other frequency domain units that are continuous in the frequency domain; or the frequency domain resource range may be one or more SCs, RBs, RB sets, BWPs or other frequency domain units that are discontinuous in the frequency domain, and so on.

In embodiments of the present disclosure, the terminal determines the configuration information for performing channel detection according to the high-level signaling, and the configuration information includes the channel detection mechanism. The channel detection mechanism indicates the method for channel detection and the channel detection configuration. Thus, the terminal may perform channel detection according to the determined channel detection mechanism, and may achieve efficient channel detection.

In embodiments of the present disclosure, the terminal determines the configuration information for performing channel detection, and the configuration information includes the frequency domain channel unit for the channel detection. Thus, the terminal may perform channel detection on the frequency domain channel unit for channel detection, thereby achieving efficient channel detection.

The frequency domain channel unit for channel detection may indicate the basic channel unit for performing channel detection. The basic channel unit may be one or more SCs, RBs, RB sets, BWPs or other frequency domain units that are continuous in the frequency domain; or the basic channel unit may also be one or more SCs, RBs, RB sets, BWPs or other frequency domain units that are discontinuous in the frequency domain, and so on.

For example, 6 RBs are used as a basic channel detection unit, or 10 MHz bandwidth is used as a basic channel unit.

It should be noted that the above embodiments are not exhaustive but are only illustrations of some embodiments, and the above embodiments may be implemented individually or in combination. The above embodiments are only for illustration and are not intended to be specific limitations on the scope of protection of the embodiments of the present disclosure.

In embodiments of the present disclosure, after the terminal determines the configuration information for performing channel detection, it may perform channel detection on the time domain resource and/or the frequency domain resource indicated by the configuration information to obtain a channel detection result.

In some other possible implementations, determining by the terminal to perform the channel detection before performing the uplink transmission to the base station includes: determining a first time domain position; and determining to perform the channel detection at the first time domain position before performing the uplink transmission to the base station, and generating a channel detection result.

In embodiments of the present disclosure, the terminal may perform channel detection at a first time domain position, in which the terminal may determine the first time domain position, and the terminal may determine the first time domain position based on an implementation, or based on an indication by the base station, or based on a protocol agreement, and so on.

In a case where the terminal determines the first time domain position, it may perform channel detection at the first time domain position and generate a channel detection result before performing uplink transmission to the base station.

For example, the terminal performs channel detection at a first time domain position, and may perform channel detection at a position of one symbol after receiving an uplink scheduling instruction from a base station; or may also perform channel detection at a position of one first symbol before a target uplink resource scheduled by the received uplink scheduling instruction, etc.

The terminal may further report capability indication information, which represents the time information required for the terminal to complete channel detection related operations. The base station may determine the time gap between the resource where the uplink scheduling instruction is located and the scheduled resource according to the capability information reported by the terminal.

It may be understood that after the terminal performs channel detection and obtains the channel detection result, it may determine whether the detected channel is in a busy state. In a case where the channel is busy, the terminal may abandon uplink data transmission and cancel uplink transmission. Alternatively, the terminal may also determine whether the uplink transmission parameter needs to be adjusted according to the channel detection result. In a case where it is determined that the channel is busy according to the channel detection result, the terminal may adjust the uplink transmission parameter to reduce interference to the interfered terminal.

In some embodiments, the uplink transmission parameter includes at least one of:
an uplink transmission power;
an uplink transmission modulation and coding scheme, MCS, level; or
amount of resources occupied by the uplink transmission.

In embodiments of the present disclosure, the terminal determines to adjust the uplink transmission parameter according to the channel detection result, and may determine to adjust the uplink transmission power.

In embodiments of the present disclosure, the terminal determines to adjust the uplink transmission parameter according to the channel detection result, and may determine to adjust the uplink transmission MCS.

In embodiments of the present disclosure, the terminal determines to adjust the uplink transmission parameter according to the channel detection result, and may determine to adjust the amount of resources occupied by the uplink transmission.

It should be noted that the above embodiments are not exhaustive but are only illustrations of some embodiments, and the above embodiments may be implemented individually or in combination. The above embodiments are only for illustration and are not intended to be specific limitations on the scope of protection of the embodiments of the present disclosure.

In some possible implementations, in case that the terminal determines to adjust the uplink transmission parameter according to the channel detection result, the terminal may adjust the uplink transmission parameter according to the channel detection result in a predefined manner to determine the adjusted uplink transmission parameter.

The predefined manner may be pre-indicated by the base station or pre-indicated by a protocol, and so on.

In other possible implementations, in case that the terminal determines to adjust the uplink transmission parameter according to the channel detection result, the terminal may adjust the uplink transmission parameter according to a correspondence between the channel detection result and a parameter adjustment mode. In a case where the target parameter adjustment mode is determined based on the channel detection result and the correspondence, the terminal adjusts the uplink transmission parameter according to the target parameter adjustment mode, to determine the adjusted uplink transmission parameter.

The correspondence between the channel detection result and the parameter adjustment mode may be determined by the terminal according to an implementation, or according to the indication by the base station, or according to the protocol agreement.

In a case where the terminal determines the correspondence between the channel detection result and the parameter adjustment mode according to the indication by the base station, it may be determined according to the high-level signaling or the physical layer signaling sent by the base station.

For example, the correspondence between the channel detection result and the parameter adjustment mode is shown in the Table 1 below.

TABLE 1

| Channel detection result | Parameter adjustment mode |
|---|---|
| Less than or equal to threshold 1 | No need to adjust transmission |
| | parameters |
| Greater than the threshold 1, | Transmission parameter offset value 1 |
| and less than or equal to | |
| threshold 2 | |
| Greater than threshold 2 | Transmission parameter offset value 2 |

It may be understood that each element in Table 1 exists independently. For example, these elements are listed in the same table, but it does not mean that all elements in the table must exist at the same time as shown in the table. The value of each element is independent of the value of any other element in Table 1. Therefore, those skilled in the art may understand that the value of each element in Table 1 is an independent embodiment.

By implementing the embodiments of the present disclosure, in a case where it is determined that interference caused by uplink transmission to an interfered terminal meets a second condition, the terminal determines to perform channel detection before performing uplink transmission to a base station. Thus, it is possible to realize efficient channel detection, and control uplink transmission according to the channel detection result obtained by performing channel detection, thereby avoiding interference and improving the performance of the system.

Reference is made to FIG. 7, which is a flow chart of yet another method for channel detection provided in an embodiment of the present disclosure.

As shown in FIG. 7, the method is performed by a terminal, and may include but is not limited to the following steps.

In step S71: in response to determining that interference caused by uplink transmission to an interfered terminal meets a second condition, the terminal receives a high-level signaling sent by the base station; and determines configuration information for performing the channel detection according to the high-level signaling.

In step S72: the terminal performs channel detection on the time domain resource and/or the frequency domain resource indicated by the configuration information, and generates a channel detection result.

In step S73: in response to the channel detection result indicating that the channel is busy, the terminal determines to cancel uplink data transmission.

In embodiments of the present disclosure, the terminal may receive a high-level signaling from the base station, such as a system signaling, an RRC signaling, an MAC CE, a physical layer signaling, or the like. The configuration information for performing channel detection is determined according to the high-level signaling from the base station.

The configuration information includes one or more of the time domain configuration, frequency domain configuration, a channel detection mechanism, and a frequency domain unit for performing channel detection with which the terminal may determine to perform channel access. Thus, the terminal may determine to perform channel detection on the time domain resource and/or the frequency domain resource indicated by the configuration information based on the configuration information.

In some embodiments, the configuration information includes at least one of:
a time domain resource range for performing the channel detection;
a frequency domain resource range for performing the channel detection;
a channel detection mechanism; or
a frequency domain channel unit for the channel detection.

In embodiments of the present disclosure, the terminal determines the configuration information for performing channel detection according to the high-level signaling, and the configuration information includes the time domain resource range for performing channel detection. Thus, the terminal may perform channel detection within the time domain resource range, and may achieve efficient channel detection.

The time domain resource range may be one or more OFDM symbols, time slots, sub-frames, radio frames or other time domain units that are continuous in the time domain; or the time domain resource range may also be one or more OFDM symbols, time slots, sub-frames, radio frames or other time domain units that are discontinuous in the time domain, and so on.

In embodiments of the present disclosure, the terminal determines the configuration information for performing channel detection according to the high-level signaling, and the configuration information includes the frequency domain resource range for performing channel detection. Thus, the terminal may perform channel detection within the frequency domain resource range, and may achieve efficient channel detection.

The frequency domain resource range may be one or more SCs, RBs, RB sets, BWPs or other frequency domain units that are continuous in the frequency domain; or the frequency domain resource range may be one or more SCs, RBs, RB sets, BWPs or other frequency domain units that are discontinuous in the frequency domain, and so on.

In embodiments of the present disclosure, the terminal determines the configuration information for performing channel detection according to the high-level signaling, and the configuration information includes the channel detection mechanism. The channel detection mechanism indicates the method for channel detection and the channel detection configuration. Thus, the terminal may perform channel detection according to the determined channel detection mechanism, and may achieve efficient channel detection.

In embodiments of the present disclosure, the terminal determines the configuration information for performing channel detection, and the configuration information includes the frequency domain channel unit for the channel detection. Thus, the terminal may perform channel detection on the frequency domain channel unit for channel detection, thereby achieving efficient channel detection.

The frequency domain channel unit for channel detection may indicate the basic channel unit for performing channel detection. The basic channel unit may be one or more SCs, RBs, RB sets, BWPs or other frequency domain units that are continuous in the frequency domain; or the basic channel unit may also be one or more SCs, RBs, RB sets, BWPs or other frequency domain units that are discontinuous in the frequency domain, and so on.

For example, 6 RBs are used as a basic channel detection unit, or 10 MHz bandwidth is used as a basic channel unit.

It should be noted that the above embodiments are not exhaustive but are only illustrations of some embodiments, and the above embodiments may be implemented individually or in combination. The above embodiments are only for illustration and are not intended to be specific limitations on the scope of protection of the embodiments of the present disclosure.

In embodiments of the present disclosure, after the terminal determines the configuration information for performing channel detection, it may perform channel detection on the time domain resource and/or the frequency domain resource indicated by the configuration information to obtain a channel detection result.

In embodiments of the present disclosure, after the terminal performs channel detection and obtains the channel detection result, it may determine to cancel uplink transmission.

It should be noted that in embodiments of the present disclosure, S71 to S73 may be implemented separately or in combination with any one of the other steps in embodiments of the present disclosure, for example, in combination with S61 in embodiments of the present disclosure, and it is not limited in embodiments of the present disclosure.

By implementing the embodiments of the present disclosure, in response to determining that interference caused by uplink transmission to an interfered terminal meets a second condition, the terminal receives a high-level signaling sent by the base station; and determines configuration information for performing the channel detection according to the high-level signaling. The terminal performs channel detection on the time domain resource and/or the frequency domain resource indicated by the configuration information, and generates a channel detection result. In response to the channel detection result indicating that the channel is busy, the terminal determines to cancel uplink transmission. In this way, it is possible to realize efficient channel detection, and control uplink transmission according to the channel detection result obtained by performing channel detection, thereby avoiding interference and improving the performance of the system.

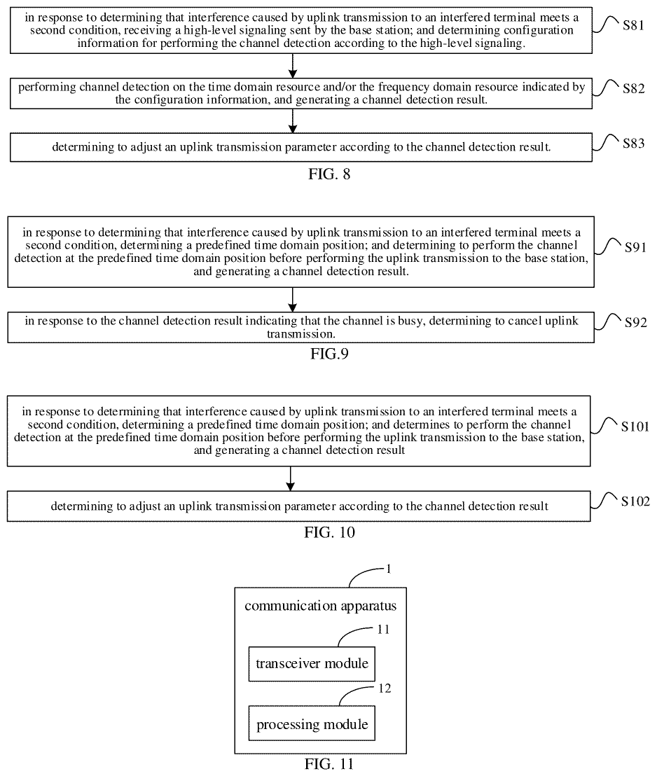

Reference is made to FIG. 8, which is a flow chart of yet another method for channel detection provided in an embodiment of the present disclosure.

As shown in FIG. 8, the method is performed by a terminal, and may include but is not limited to the following steps.

In step S81: in response to determining that interference caused by uplink transmission to an interfered terminal meets a second condition, the terminal receives a high-level signaling sent by the base station; and determines configuration information for performing the channel detection according to the high-level signaling.

In step S82: the terminal performs channel detection on the time domain resource and/or the frequency domain resource indicated by the configuration information, and generates a channel detection result.

Regarding the relevant descriptions of S81 and S82, reference may be made to the relevant descriptions in the above embodiments, which will not be repeated here.

In step S83: the terminal determines to adjust an uplink transmission parameter according to the channel detection result.

It may be understood that after the terminal performs channel detection and obtains the channel detection result, it may determine whether the uplink transmission parameter needs to be adjusted according to the channel detection result. In a case where it is determined that the channel is busy according to the channel detection result, the terminal may adjust the uplink transmission parameter to reduce interference to the interfered terminal.

In some embodiments, the uplink transmission parameter includes at least one of:
an uplink transmission power;
an uplink transmission modulation and coding scheme, MCS, level; or
amount of resources occupied by the uplink transmission.

In embodiments of the present disclosure, the terminal determines to adjust the uplink transmission parameter according to the channel detection result, and may determine to adjust the uplink transmission power.

In embodiments of the present disclosure, the terminal determines to adjust the uplink transmission parameter according to the channel detection result, and may determine to adjust the uplink transmission MCS.

In embodiments of the present disclosure, the terminal determines to adjust the uplink transmission parameter according to the channel detection result, and may determine to adjust the amount of resources occupied by the uplink transmission.

It should be noted that the above embodiments are not exhaustive but are only illustrations of some embodiments, and the above embodiments may be implemented individually or in combination. The above embodiments are only for illustration and are not intended to be specific limitations on the scope of protection of the embodiments of the present disclosure.

In some possible implementations, in case that the terminal determines to adjust the uplink transmission parameter according to the channel detection result, the terminal may adjust the uplink transmission parameter according to the channel detection result in a predefined manner to determine the adjusted uplink transmission parameter.

The predefined manner may be pre-indicated by the base station or pre-indicated by a protocol, and so on.

In other possible implementations, in case that the terminal determines to adjust the uplink transmission parameter according to the channel detection result, the terminal may adjust the uplink transmission parameter according to a correspondence between the channel detection result and a parameter adjustment mode. In a case where the target parameter adjustment mode is determined based on the channel detection result and the correspondence, the terminal adjusts the uplink transmission parameter according to the target parameter adjustment mode, to determine the adjusted uplink transmission parameter.

The correspondence between the channel detection result and the parameter adjustment mode may be determined by the terminal according to an implementation, or according to the indication by the base station, or according to the protocol agreement.

In a case where the terminal determines the correspondence between the channel detection result and the parameter adjustment mode according to the indication by the base station, it may be determined according to the high-level signaling or the physical layer signaling sent by the base station.

For example, the correspondence between the channel detection result and the parameter adjustment mode is shown in the above Table 1.

It should be noted that in embodiments of the present disclosure, S81 to S83 may be implemented separately or in combination with any one of the other steps in embodiments of the present disclosure, for example, in combination with S61 in embodiments of the present disclosure, and it is not limited in embodiments of the present disclosure.

By implementing the embodiments of the present disclosure, in response to determining that interference caused by uplink transmission to an interfered terminal meets a second condition, the terminal receives a high-level signaling sent by the base station; and determines configuration information for performing the channel detection according to the high-level signaling. The terminal performs channel detection on the time domain resource and/or the frequency domain resource indicated by the configuration information, and generates a channel detection result. The terminal determines to adjust an uplink transmission parameter according to the channel detection result. In this way, it is possible to realize efficient channel detection, and adjust the uplink transmission parameter according to the channel detection result obtained by performing channel detection, thereby avoiding interference and improving the performance of the system.

Reference is made to FIG. 9, which is a flow chart of yet another method for channel detection provided in an embodiment of the present disclosure.

As shown in FIG. 9, the method is performed by a terminal, and may include but is not limited to the following steps.

In step S91: in response to determining that interference caused by uplink transmission to an interfered terminal meets a second condition, the terminal determines a first time domain position; and determines to perform the channel detection at the first time domain position before performing the uplink transmission to the base station, and generating a channel detection result.

In step S92: in response to the channel detection result indicating that the channel is busy, the terminal determines to cancel uplink transmission.

In embodiments of the present disclosure, the terminal may perform channel detection at a first time domain position, in which the terminal may determine the first time domain position, and the terminal may determine the first time domain position based on an implementation, or based on an indication by a base station, or based on a protocol agreement, and so on.

In a case where the terminal determines the first time domain position, it may perform channel detection at the first time domain position before performing uplink transmission to the base station, and generate a channel detection result.

For example, the terminal performs channel detection at a first time domain position, and may perform channel detection at a position of one symbol after receiving an uplink scheduling instruction from a base station; or may also perform channel detection at a position of one first symbol before a target uplink resource scheduled by the received uplink scheduling instruction, etc.

The terminal may further report capability indication information, which represents the time information required for the terminal to complete channel detection related operations. The base station may determine the time gap between the resource where the uplink scheduling instruction is located and the scheduled resource according to the capability information reported by the terminal.

It may be understood that after the terminal performs channel detection and obtains the channel detection result, it may determine whether the detected channel is in a busy state. In a case where the channel is busy, the terminal may abandon uplink data transmission and cancel uplink transmission.

It should be noted that in embodiments of the present disclosure, S91 to S92 may be implemented separately or in combination with any one of the other steps in embodiments of the present disclosure, for example, in combination with S61 in embodiments of the present disclosure, and it is not limited in embodiments of the present disclosure.

By implementing the embodiments of the present disclosure, in response to determining that interference caused by uplink transmission to an interfered terminal meets a second condition, the terminal determines a first time domain position; and determines to perform the channel detection at the first time domain position before performing the uplink transmission to the base station, and generating a channel detection result. In response to the channel detection result indicating that the channel is busy, the terminal determines to cancel uplink transmission. In this way, it is possible to realize efficient channel detection, and control uplink transmission according to the channel detection result obtained by performing channel detection, thereby avoiding interference and improving the performance of the system.

Reference is made to FIG. 10, which is a flow chart of yet another method for channel detection provided in an embodiment of the present disclosure.

As shown in FIG. 10, the method is performed by a terminal, and may include but is not limited to the following steps.

In step S101: in response to determining that interference caused by uplink transmission to an interfered terminal meets a second condition, the terminal determines a first time domain position; and determines to perform the channel detection at the first time domain position before performing the uplink transmission to the base station, and generating a channel detection result.

Regarding the relevant descriptions of S101, reference may be made to the relevant descriptions in the above embodiments, which will not be repeated here.

In step S102: the terminal determines to adjust an uplink transmission parameter according to the channel detection result.

In some possible implementations, in case that the terminal determines to adjust the uplink transmission parameter according to the channel detection result, the terminal may adjust the uplink transmission parameter according to the channel detection result in a predefined manner to determine the adjusted uplink transmission parameter.

The predefined manner may be pre-indicated by the base station or pre-indicated by the protocol, and so on.

In other possible implementations, in case that the terminal determines to adjust the uplink transmission parameter according to the channel detection result, the terminal may adjust the uplink transmission parameter according to a correspondence between the channel detection result and a parameter adjustment mode. In a case where the target parameter adjustment mode is determined based on the channel detection result and the correspondence, the terminal adjusts the uplink transmission parameter according to the target parameter adjustment mode, to determine the adjusted uplink transmission parameter.

The correspondence between the channel detection result and the parameter adjustment mode may be determined by the terminal according to an implementation, or according to the indication by the base station, or according to the protocol agreement.

In a case where the terminal determines the correspondence between the channel detection result and the parameter adjustment mode according to the indication by the base station, it may be determined according to the high-level signaling or the physical layer signaling sent by the base station.

For example, the correspondence between the channel detection result and the parameter adjustment mode is shown in the above Table 1.

It should be noted that in embodiments of the present disclosure, S101 to S102 may be implemented separately or in combination with any one of the other steps in embodiments of the present disclosure, for example, in combination with S61 in embodiments of the present disclosure, and it is not limited in embodiments of the present disclosure.

By implementing the embodiments of the present disclosure, in response to determining that interference caused by uplink transmission to an interfered terminal meets a second condition, the terminal determines a first time domain position; and determines to perform the channel detection at the first time domain position before performing the uplink transmission to the base station, and generating a channel detection result. The terminal determines to adjust an uplink transmission parameter according to the channel detection result. In this way, it is possible to realize efficient channel detection, and adjust the uplink transmission parameter according to the channel detection result obtained by performing channel detection, thereby avoiding interference and improving the performance of the system.

In the above-mentioned embodiments provided by the present disclosure, the methods provided in the embodiments of the present disclosure are introduced from the perspectives of the terminal, the base station, and the interaction between the terminal and the base station.

Reference is made to FIG. 11, which is a schematic block diagram of a communication apparatus 1 provided in an embodiment of the present disclosure. The communication apparatus 1 shown in FIG. 11 may comprise a transceiver module 11 and a processing module 12. The transceiver module may include a transmitting module and/or a receiving module, the transmitting module is configured to implement a sending function, the receiving module is configured to implement a receiving function, and the transceiver module may implement a sending function and/or a receiving function.

The communication apparatus 1 may be a terminal, an apparatus in a terminal, or an apparatus that may be used in conjunction with a terminal. Alternatively, the communication apparatus 1 may be a base station, an apparatus in a base station, or an apparatus that may be used in conjunction with a base station.

The communication apparatus 1 is a base station.

The apparatus includes: a processing module 12.

The processing module 12 is configured to determine to perform channel detection before performing downlink transmission to a terminal, in response to determining that interference caused by downlink transmission to an interfered cell of an interfered base station meets a first condition.

In some embodiments, the processing module 12 is further configured to determine auxiliary information of the interfered base station corresponding to the interfered cell, and determine configuration information for performing channel detection according to the auxiliary information.

In some embodiments, the configuration information comprises at least one of:
a time domain resource range for performing the channel detection;
a frequency domain resource range for performing the channel detection;
a channel detection mechanism; or
a frequency domain channel unit for the channel detection.

As shown in FIG. 11, in some embodiments, the apparatus further comprises: a transceiver module 11.

The transceiver module 11 is configured to send indication information to the terminal, wherein the indication information is configured to indicate, to the terminal, to cancel uplink transmission on a time domain resource and/or a frequency domain resource indicated by the configuration information.

In some embodiments, the processing module 12 is further configured to perform channel detection on a time domain resource and/or a frequency domain resource indicated by the configuration information, and generating a channel detection result.

In some embodiments, the processing module 12 is further configured to cancel downlink data transmission or adjust downlink transmission parameter in response to the channel detection result indicating that a channel resource is occupied.

The communication apparatus 1 is a terminal:

The apparatus includes: a transceiver module 11 and a processing module 12.

The transceiver module 11 is configured to receive indication information sent by a base station, wherein the indication information is configured to indicate, to a terminal, to cancel uplink transmission on a time domain resource and/or a frequency domain resource indicated by configuration information; and the configuration information is determined by the base station according to auxiliary information of an interfered base station corresponding to an interfered cell in a case where it is determined that interference caused by downlink transmission to the interfered cell of the interfered base station meets a preset condition;

The processing module 12 is configured to cancel, according to the indication information, the uplink transmission on the time domain resource and/or the frequency domain resource indicated by the configuration information.

In some embodiments, the configuration information comprises at least one of:
a time domain resource range for performing the channel detection;
a frequency domain resource range for performing the channel detection;
a channel detection mechanism; or
a frequency domain channel unit for the channel detection.

The communication apparatus 1 is a terminal.

The apparatus includes: a processing module 12.

The processing module 12 is configured to determine to perform channel detection before performing uplink transmission to a base station, in response to determining that interference caused by uplink transmission to an interfered terminal meets a preset condition.

As shown in FIG. 11, in some embodiments, the apparatus further comprises: a transceiver module 11.

The transceiver module 11 is configured to receive a high-level signaling sent by the base station.

The processing module 12 is further configured to determine configuration information for performing the channel detection according to the high-level signaling.

In some embodiments, the configuration information comprises at least one of:
a time domain resource range for performing the channel detection;
a frequency domain resource range for performing the channel detection;
a channel detection mechanism; or
a frequency domain channel unit for the channel detection.

In some embodiments, the processing module 12 is further configured to perform the channel detection on a time domain resource and/or a frequency domain resource indicated by the configuration information, and generating a channel detection result.

In some embodiments, the processing module 12 is further configured to determine a first time domain position, and determine to perform the channel detection at the first time domain position before performing the uplink transmission to the base station, and generate a channel detection result.

In some embodiments, the processing module 12 is further configured to determine to cancel the uplink transmission in response to the channel detection result indicating that the channel is busy.

In some embodiments, the processing module 12 is further configured to determine to adjust an uplink transmission parameter according to the channel detection result.

In some embodiments, the processing module 12 is further configured to determine a correspondence between the channel detection result and a parameter adjustment mode; and in response to determining a target parameter adjustment mode according to the channel detection result and the correspondence, adjust the uplink transmission parameter according to the target parameter adjustment mode.

In some embodiments, the uplink transmission parameter comprises at least one of:
an uplink transmission power;
an uplink transmission modulation and coding scheme, MCS, level; or
amount of resources occupied by the uplink transmission.

Regarding the communication apparatus 1 in the above embodiment, the specific manner in which each module performs operations has been described in detail in the embodiment of the corresponding method, and will not be elaborated here.

The communication apparatus 1 provided in the above embodiments of the present disclosure achieves the same or similar beneficial effects as the methods for channel detection provided in some of the above embodiments, which will not be described in detail here.

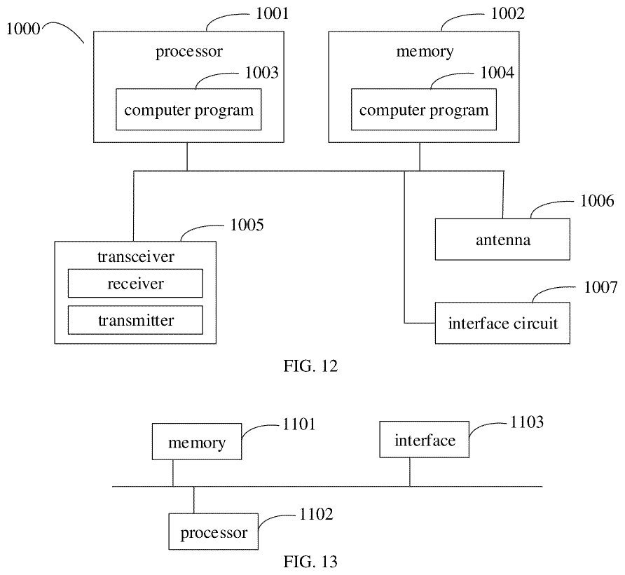

Referring to FIG. 12, FIG. 12 is a schematic block diagram of another communication apparatus 1000 provided by embodiments of the present disclosure. The communication apparatus 1000 may be a base station, may also be a terminal, may also be a chip, a chip system, or a processor that supports the base station to implement the above method, or may also be a chip, a chip system, or a processor that supports the terminal to implement the above method. The communication apparatus 1000 may be used to implement the methods as described in the above method embodiments, and for details, reference may be made to the descriptions on the above method embodiments.

The communication apparatus 1000 may include one or more processors 1001. The communication processor 1001 may be a general-purpose processor or a special-purpose processor. For example, it may be a baseband processor or a central processing unit. The baseband processor may be configured to process a communication protocol and communication data, and the central processing unit may be configured to control the communication apparatus (such as a network device, a baseband chip, a terminal, a terminal chip, a DU or a CU, etc.), execute computer programs, and process data of computer programs.

Optionally, the communication apparatus 1000 may further include one or more memories 1002 that may have stored therein computer programs 1004. The memories 1002 executes the computer programs 1004 to cause the communication apparatus 1000 to implement the methods as described in the above method embodiments. Optionally, the memory 1002 may have stored therein data. The communication apparatus 1000 and the memory 1002 may be set separately or integrated together.

Optionally, the communication apparatus 1000 may further include a transceiver 1005 and an antenna 1006. The transceiver 1005 may be called a transceiving unit, a transceiving machine, a transceiving circuit or the like, for implementing a transceiving function. The transceiver 1005 may include a receiver and a transmitter. The receiver may be called a receiving machine, a receiving circuit or the like, for implementing a receiving function. The transmitter may be called a sending machine, a sending circuit or the like for implementing a sending function.

Optionally, the communication apparatus 1000 may further include one or more interface circuits 1007. The interface circuit 1007 is configured to receive code instructions and transmit the code instructions to the processor 1001. The processor 1001 runs the code instructions to enable the communication apparatus 1000 to execute the methods as described in the foregoing method embodiments.

In the case where the communication apparatus 1000 is a base station, the processor 1001 is configured to execute step S31 in FIG. 3; step S41 in FIG. 4; steps S51, step S52 and S53 in FIG. 5; and the transceiver 1005 is configured to execute step S42 in FIG. 4.

In the case where the communication apparatus 1000 is a terminal, the transceiver 1005 is configured to execute step S42 in FIG. 4; and the processor 1001 is configured to execute step S43 in FIG. 4.

In the case where the communication apparatus 1000 is a terminal, the processor 1001 is configured to execute step S61 in FIG. 6; steps S71, S72 and S73 in FIG. 7; steps S81, S82 and S83 in FIG. 8; steps S91 and S92 in FIG. 9; and steps S101 and S102 in FIG. 10.

In an implementation, the processor 1001 may include the transceiver configured to implement receiving and sending functions. For example, the transceiver may be a transceiving circuit, an interface, or an interface circuit. The transceiving circuit, the interface or the interface circuit configured to implement the receiving and sending functions may be separated or may be integrated together. The above transceiving circuit, interface or interface circuit may be configured to read and write codes/data, or the above transceiving circuit, interface or interface circuit may be configured to transmit or transfer signals.

In an implementation, the processor 1001 may have stored therein computer programs 1003, which is executed on the processor 1001 to cause the communication apparatus 1000 to implement the methods as described in the above method embodiments. The computer programs 1003 may be solidified in the processor 1001, and in this case, the processor 1001 may be implemented by hardware.

In an implementation, the communication apparatus 1000 may include a circuit, and the circuit may implement the sending, receiving or communicating function in the foregoing method embodiments. The processor and the transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver may also be manufactured using various IC process technologies, such as a complementary metal oxide semiconductor (CMOS), an nMetal-oxide-semiconductor (NMOS), a P-type metal oxide semiconductor (also called positive channel metal oxide semiconductor, PMOS), a bipolar junction transistor (BJT), a bipolar CMOS (BiCMOS), silicon germanium (SiGe), gallium arsenide (GaAs), etc.

The communication apparatus described in the above embodiments may be the network device or the terminal, but the scope of the communication apparatus described in the present disclosure is not limited thereto, and a structure of the communication apparatus is not limited by FIG. 12. The communication apparatus may be a stand-alone device or may be a part of a larger device. For example, the communication apparatus may be:
(1) a stand-alone integrated circuit (IC), or a chip, or a chip system or a subsystem;
(2) a set of one or more ICs, optionally, the set of ICs may also include a storage component for storing data and computer programs;
(3) an ASIC, such as a modem;
(4) a module that may be embedded in other devices;
(5) a receiver, a terminal, an intelligent terminal, a cellular phone, a wireless device, a handheld machine, a mobile unit, a vehicle device, a network device, a cloud device, an artificial intelligence device, etc.;
(6) others.

For the case where the communication apparatus may be a chip or a chip system, reference may be made to a structural diagram of the chip shown in FIG. 13.

The chip 1100 includes a processor 1101 and an interface 1103. In the chip, one or more processors 1101 may be provided, and a plurality of interfaces 1103 may be provided.

For the case where the chip is used to implement the functions of the terminal in some embodiments of the present disclosure:
the interface 1103 is configured to receive code instructions and transmit the code instructions to the processor; and
the processor 1101 is configured to run code instructions to execute the method for channel detection as described in some of the above embodiments.

For the case where the chip is used to implement functions of the base station in some embodiments of the present disclosure:
the interface 1103 is configured to receive code instructions and transmit the code instructions to the processor; and
the processor 1101 is configured to run code instructions to execute the method for channel detection as described in some of the above embodiments.

Optionally, the chip 1100 further includes a memory 1102 for storing necessary computer programs and data.

Those skilled in the art may also understand that various illustrative logical blocks and steps listed in embodiments of the present disclosure may be implemented by electronic hardware, computer software, or a combination thereof. Whether such functions are implemented by hardware or software depends on specific applications and design requirements of an overall system. For each specific application, those skilled in the art may use various methods to implement the described functions, but such implementation should not be understood as beyond the protection scope of embodiments of the present disclosure.

Embodiments of the present disclosure also provide a system for channel detection, which includes the communication apparatus as a terminal and the communication apparatus as a base station in the embodiment of FIG. 11, or the communication apparatus as a terminal and the communication apparatus as a base station in the embodiment of FIG. 12.

The present disclosure also provides a readable storage medium having stored therein instructions that, when executed by a computer, cause functions of any of the above method embodiments to be implemented.

The present disclosure also provides computer program product that, when executed by a computer, causes functions of any of the above method embodiments to be implemented.

The above embodiments may be implemented in whole or in part by software, hardware, firmware or any combination thereof. When implemented using the software, the above embodiments may be implemented in whole or in part in a form of the computer program product. The computer program product includes one or more computer programs. When the computer programs are loaded and executed on the computer, all or part of the processes or functions according to embodiments of the present disclosure will be generated. The computer may be a general purpose computer, a special purpose computer, a computer network, or other programmable devices. The computer programs may be stored in a computer-readable storage medium or transmitted from one computer-readable storage medium to another computer-readable storage medium. For example, the computer programs may be transmitted from one website site, computer, server or data center to another website site, computer, server or data center in a wired manner (such as via a coaxial cable, an optical fiber, a digital subscriber line (DSL)) or a wireless manner (such as via infrared, wireless, or microwave, etc.). The computer-readable storage medium may be any available medium that can be accessed by the computer, or a data storage device such as a server or a data center integrated by one or more available media. The available medium may be a magnetic medium (for example, a floppy disk, a hard disk, or a magnetic tape), an optical medium (for example, a high-density digital video disc (DVD)), or a semiconductor medium (for example, a solid state disk (SSD)), etc.

Those of ordinary skill in the art can understand that the first, second, and other numeral numbers involved in the present disclosure are only for convenience of description, and are not intended to limit the scope of embodiments of the present disclosure, nor are they intended to represent a sequential order.

The term “at least one” used in the present disclosure may also be described as one or more, and the term “a plurality of” may cover two, three, four or more, which are not limited in the present disclosure. In embodiments of the present disclosure, for a certain kind of technical features, the technical features in this kind of technical features are distinguished by terms like “first”, “second”, “third”, “A”, “B”, “C” and “D”, etc., and these technical features described with the “first”, “second”, “third”, “A”, “B”, “C” and “D” have no order of priority and have no order of size.

The correspondence shown in each table in the present disclosure may be configured or predefined. The values of various information in each table are just examples, and may be configured as other values, which are not limited in the present disclosure. When configuring a correspondence between the information and various parameters, it is not necessary to configure all the correspondences shown in the tables. For example, the correspondences shown in some rows of a table in the present disclosure may not be configured. For another example, appropriate deformations or adjustments (such as splitting, merging, and so on) can be made based on the above table. The names of parameters shown in the titles of the above tables may also adopt other names understandable by the communication apparatus, and the values or representations of the parameters may also be other values or representations understandable by the communication apparatus. When the above tables are implemented, other data structures may also be used, for example, arrays, queues, containers, stacks, linear tables, pointers, linked lists, trees, graphs, structural body, classes, heaps, or hash tables may be used.

The term “predefinition” in the present disclosure may be understood as definition, definition in advance, storage, pre-storage, pre-negotiation, pre-configuration, curing, or pre-firing.

Those of ordinary skill in the art can appreciate that the units and algorithm steps of various examples described in conjunction with embodiments disclosed herein may be implemented by the electronic hardware, or a combination of the computer software and the electronic hardware. Whether these functions are executed by the hardware or the software depends on the specific applications and design constraints of the technical solution. For each particular application, those skilled in the art may use different methods to implement the described functions, but such implementation should not be considered beyond the scope of the present disclosure.

Those skilled in the art can clearly understand that for the convenience and brevity of the description, the specific working process of the above-described system, device and unit may refer to the corresponding process in the foregoing method embodiments, which will not be repeated here.

The above is only a specific embodiment of the present disclosure, but the protection scope of the present disclosure is not limited thereto. Any person skilled in the art who is familiar with the technical field may easily think of changes or substitutions within the technical scope disclosed in the present disclosure, which should be included in the protection scope of the present disclosure. Therefore, the protection scope of the present disclosure should be based on the protection scope of the claims.

1. A method for channel detection, performed by a base station, comprising:
in response to determining that interference caused by downlink transmission to an interfered cell of an interfered base station meets a first condition, determining to perform channel detection before performing downlink transmission to a terminal.

2. The method according to claim 1, wherein determining to perform the channel detection before the downlink transmission to the terminal comprises:
determining auxiliary information of the interfered base station; and
determining configuration information for performing the channel detection according to the auxiliary information.

3. The method according to claim 2, wherein the configuration information comprises at least one of:
a time domain resource range for performing the channel detection;
a frequency domain resource range for performing the channel detection;
a channel detection mechanism; or
a frequency domain channel unit for the channel detection.

4. The method according to claim 2, further comprising:
sending indication information to the terminal, wherein the indication information is configured to indicate, to the terminal, to cancel uplink transmission on at least one of a time domain resource or a frequency domain resource indicated by the configuration information.

5. The method according to claim 2, further comprising:
performing the channel detection on at least one of a time domain resource or a frequency domain resource indicated by the configuration information, and generating a channel detection result.

6. The method according to claim 5, further comprising:
in response to the channel detection result indicating that a channel resource is occupied, canceling downlink data transmission, or adjusting a downlink transmission parameter.

7. A method for channel detection, performed by a terminal, comprising:
receiving indication information sent by a base station, wherein the indication information is configured to indicate, to the terminal, to cancel uplink transmission on at least one of a time domain resource or a frequency domain resource indicated by configuration information; and the configuration information is determined by the base station according to auxiliary information of an interfered base station corresponding to an interfered cell in a case where it is determined that interference caused by downlink transmission to the interfered cell of the interfered base station meets a first condition; and
canceling, according to the indication information, the uplink transmission on at least one of the time domain resource or the frequency domain resource indicated by the configuration information.

8. The method according to claim 7, wherein the configuration information comprises at least one of:
a time domain resource range for performing the channel detection;
a frequency domain resource range for performing the channel detection;
a channel detection mechanism; or
a frequency domain channel unit for the channel detection.

9. A method for channel detection, performed by a terminal, comprising:
in response to determining that interference caused by uplink transmission to an interfered terminal meets a second condition, determining to perform channel detection before performing uplink transmission to a base station.

10. The method according to claim 9, wherein determining to perform the channel detection before performing the uplink transmission to the base station comprises:
receiving a high-level signaling sent by the base station; and
determining configuration information for performing the channel detection according to the high-level signaling.

11. The method according to claim 10, wherein the configuration information comprises at least one of:
a time domain resource range for performing the channel detection;
a frequency domain resource range for performing the channel detection;
a channel detection mechanism; or
a frequency domain channel unit for the channel detection.

12. The method according to claim 10, further comprising:
performing the channel detection on at least one of a time domain resource or a frequency domain resource indicated by the configuration information, and generating a channel detection result.

13. The method according to claim 9, wherein determining to perform the channel detection before performing the uplink transmission to the base station comprises:
determining a first time domain position; and
determining to perform the channel detection at the first time domain position before performing the uplink transmission to the base station, and generating a channel detection result.

14. The method according to claim 12, further comprising:
in response to the channel detection result indicating that the channel is busy, determining to cancel the uplink transmission.

15. The method according to claim 12, further comprising:
determining to adjust an uplink transmission parameter according to the channel detection result.

16. The method according to claim 15, wherein determining to adjust the uplink transmission parameter according to the channel detection result comprises:
determining a correspondence between the channel detection result and a parameter adjustment mode; and
in response to determining a target parameter adjustment mode according to the channel detection result and the correspondence, adjusting the uplink transmission parameter according to the target parameter adjustment mode.

17. The method according to claim 15, wherein the uplink transmission parameter comprises at least one of:
an uplink transmission power;
an uplink transmission modulation and coding scheme, MCS, level; or
amount of resources occupied by the uplink transmission.

18.-20. (canceled)

21. A base station, comprising:
a processor; and
a memory, having stored therein computer programs,
wherein the processor is configured to perform the method according to claim 1.

22.-23. (canceled)

24. A terminal, comprising:
a processor; and
a memory, having stored therein computer programs,
wherein the processor is configured to perform the method according to claim 7.

25. A terminal, comprising:
a processor; and
a memory, having stored therein computer programs,
wherein the processor is configured to perform the method according to claim 9.
